(19) United States
(12) Patent Application Publication
(10) Pub. No.: US 2013/0107668 A1
(43) Pub. Date: May 2, 2013

(54) CONVOY-BASED SYSTEMS AND METHODS FOR LOCATING AN ACOUSTIC SOURCE

(71) Applicants: Joel N. Holyoak, Lucas, TX (US); Joseph Vincent Culotta, JR., Coppell, TX (US)

(72) Inventors: Joel N. Holyoak, Lucas, TX (US); Joseph Vincent Culotta, JR., Coppell, TX (US)

(73) Assignee: RAYTHEON COMPANY, Waltham, MA (US)

(21) Appl. No.: 13/283,997

(22) Filed: Oct. 28, 2011

(51) Int. Cl. G01S 3/80

(52) U.S. Cl. 367/118

(57) ABSTRACT

A method of locating an acoustic source using a plurality of vehicles is provided. The method includes transferring acoustic input from a plurality of sensors to a plurality of processing modules, determining a location of each of the vehicles using at least one of a global positioning system module and an inertial motion unit module located in each vehicle, processing, at each processing module, the received acoustic input, designating one of the processing modules a master processing module, and sending processed acoustic input received at each processing module to the master processing module, combining the processed acoustic input at the master processing module, and estimating acoustic source location based on combined processed acoustic data. The method may further include determining if the master processing module is functional, and responsive to determining that the master processing module is not functional, designating a different one of the plurality of processing modules as the master processing module.

### BACKGROUND

There is often a need to identify the location of the source of acoustic events, such as environmental events, explosions, alarms, gunfire, etc., from a mobile platform. Some existing systems equip a vehicle with an acoustic sensor that is configured to process received acoustic signals and attempt to locate the source of the acoustic signals. For example, one system uses multiple sensors installed on a vehicle that simultaneously process received audio to identify the source and direction of the audio and provide situational awareness to the vehicle.

### SUMMARY OF INVENTION

Existing vehicle-based acoustic locating systems have several limitations. One example system has multiple sensors located on a single pole mounted on the vehicle. In another example, multiple sensors are mounted at various locations on a vehicle. Due to the limited size of the vehicle, the acoustic sensors are located in close proximity to one another, and as a result, the available spatial diversity of the sensors is insufficient for precise location identification, particularly for low frequency sounds. In addition, single-vehicle systems require the installation of several sensors (e.g., eight or more) on the vehicle. There is limited space on a single vehicle for mounting sensors, especially on a military vehicle where the space may be needed for other purposes as well.

Aspects and embodiments are directed to methods and apparatus of providing an acoustic locating system that uses an array of networked sensors distributed across multiple vehicles in a convoy. Using a networked distributed array architecture according to one embodiment may mitigate several disadvantages associated with conventional systems and provide a cost effective, precision acoustic locating system, as discussed further below.

According to one aspect, a method of locating an acoustic source using a plurality of vehicles includes transferring acoustic input from a plurality of sensors to a plurality of processing modules, determining a location of each of the plurality of vehicles using at least one of a global positioning system module and an inertial motion unit module located in each vehicle, processing, at each of the plurality of processing modules, the received acoustic input, designating one of the plurality of processing modules a master processing module, sending processed acoustic input received at each processing module to the master processing module, combining the processed acoustic input at the master processing module, and estimating acoustic source location based on combined processed acoustic data. Each of the plurality of sensors is coupled to one of the plurality of processing modules, and each of the plurality of vehicles includes at least one of the plurality of sensors and one of the plurality of processing modules.

In one embodiment, the method also includes determining if the master processing module is functional, and, responsive to determining that the master processing module is not functional, designating a different one of the plurality of processing modules as the master processing module. According to one embodiment, processing includes, at each of the plurality of processing modules, processing location information for the corresponding one of the plurality of vehicles on which the respective processing module is positioned. According to another embodiment, each of the plurality of processing modules communicates with each of the other processing modules. In a further embodiment, processing includes performing noise cancelation on the received acoustic input.

According to one embodiment, the method also includes sending first processed acoustic input received at a first processing module to a second processing module, and sending the first processed acoustic input from the second processing module to the master processing module. According to another embodiment, transferring acoustic input from the plurality of sensors includes transferring input from a plurality of arrays of sensor elements. In one embodiment, sending the processed acoustic input received at each processing module to the master processing module includes forming, with the plurality of vehicles, an interferometer base for acoustic detection.

According to one aspect, a system for locating an acoustic source includes multiple sensors, multiple processing modules, and multiple global positioning system modules. The sensors include a first sensor positioned on a first vehicle and a second sensor positioned on a second vehicle. The processing modules include a first processing module positioned on the first vehicle and coupled to the first sensor and a second processing module positioned on the second vehicle and coupled to the second sensor. The global positioning system modules include a first global positioning system module positioned on the first vehicle. The first global positioning system transmits vehicle location information to the first processing module. The processing modules are connected in a self-healing network such that each processing module is configured to receive data from the other processing modules and process the data to determine the location of an event.

According to one embodiment, the system also includes multiple inertial motion unit modules. A first inertial motion unit module is positioned on the first vehicle and transmits vehicle movement information to the first processing module. According to another embodiment, each of the sensors includes an array of sensor elements. According to a further embodiment the system includes a convoy of vehicles, and the first vehicle and the second vehicle are part of the convoy. In another embodiment, the system includes one or more noise cancelling nodes positioned on the first vehicle or the second vehicle. In one embodiment, the first and second vehicles form an interferometer base for acoustic detection.

Still other aspects, embodiments, and advantages of these exemplary aspects and embodiments, are discussed in detail below. Embodiments disclosed herein may be combined with other embodiments in any manner consistent with at least one of the principles disclosed herein, and references to “an embodiment,” “some embodiments,” “an alternate embodiment,” “various embodiments,” “one embodiment” or the like are not necessarily mutually exclusive and are intended to indicate that a particular feature, structure, or characteristic described may be included in at least one embodiment. The appearances of such terms herein are not necessarily all referring to the same embodiment.

### BRIEF DESCRIPTION OF THE FIGURES

Various aspects of at least one embodiment are discussed below with reference to the accompanying figures, which are not intended to be drawn to scale. The figures are included to provide illustration and a further understanding of the various aspects and embodiments, and are incorporated in and constitute a part of this specification, but are not intended as a definition of the limits of the invention. Where technical features in the figures, detailed description or any claim are followed by references signs, the reference signs have been included for the sole purpose of increasing the intelligibility of the figures and description. In the figures, each identical or nearly identical component that is illustrated in various figures is represented by a like numeral. For purposes of clarity, not every component may be labeled in every figure. In the figures:

FIG. 1 is a schematic diagram of one example of a sensor network node including a pair of acoustic sensors located on a convoy vehicle, according to aspects of the invention;

FIG. 2 is a schematic diagram of one example of a convoy of vehicles forming a distributed sensor array according to aspects of the invention;

FIG. 3 is a schematic diagram of an exemplary sensor, according to aspects of the invention;

FIG. 4 is a schematic diagram of a convoy of vehicles having sensors and detecting acoustic events according to aspects of the invention; and

FIG. 5 is a flow chart of one example of a convoy-based method of locating an acoustic source according to aspects of the invention.

### DETAILED DESCRIPTION

As discussed above, an acoustic location system that mounts multiple sensors on a single vehicle suffers from several disadvantages, including limited location resolution due to the limited spatial differentiation between closely co-located sensors, and the need to find substantial mounting space on the single vehicle for the sensors. In some examples, noise cancelling sensors or nodes are used to improve the signal-to-noise ratio of the signals provided by the acoustic sensors. However, since the number of noise cancelling nodes on the vehicle may be limited to only one or two (for example, due to space and/or cost constraints), when the vehicle has more than two acoustic sensors, multiple acoustic sensors may share the same noise cancelling node. Accordingly, approximations of the transfer function to each sensor may be necessary to perform noise cancellation processing, which may limit the resolution of the system. In one example, noise cancellation processing improves the accuracy of the system by reducing the effect of vehicle noise on the received signal.

Thus, there is a need for a more accurate cost-effective system for quickly locating the sources of acoustic events. Accordingly, aspects and embodiments are directed to a precision acoustic location system that includes a networked array of acoustic sensors distributed across multiple vehicles in a convoy. As discussed in more detail below, in one embodiment the sensors are configured to form an ad hoc, “self-healing” network that dynamically adjusts to the addition or removal of convoy vehicles or sensors from the network, and with any one or more of the convoy vehicles including master processing capability. This networked distributed array architecture provides a larger interferometer base for acoustic detection, thereby increasing the spatial differentiation for improved acoustic source location resolution, while also reducing the number of sensors installed on each vehicle and providing built-in redundancy, as discussed further below.

It is to be appreciated that embodiments of the methods and apparatuses discussed herein are not limited in application to the details of construction and the arrangement of components set forth in the following description or illustrated in the accompanying drawings. The methods and apparatuses are capable of implementation in other embodiments and of being practiced or of being carried out in various ways. Examples of specific implementations are provided herein for illustrative purposes only and are not intended to be limiting. In particular, acts, elements and features discussed in connection with any one or more embodiments are not intended to be excluded from a similar role in any other embodiment.

Also, the phraseology and terminology used herein is for the purpose of description and should not be regarded as limiting. Any references to embodiments or elements or acts of the systems and methods herein referred to in the singular may also embrace embodiments including a plurality of these elements, and any references in plural to any embodiment or element or act herein may also embrace embodiments including only a single element. The use herein of “including,” “comprising,” “having,” “containing,” “involving,” and variations thereof is meant to encompass the items listed thereafter and equivalents thereof as well as additional items. References to “or” may be construed as inclusive so that any terms described using “or” may indicate any of a single, more than one, and all of the described terms. Any references to front and back, left and right, top and bottom, upper and lower, and vertical and horizontal are intended for convenience of description, not to limit the present systems and methods or their components to any one positional or spatial orientation.

Referring to FIG. 1, there is illustrated a schematic diagram of one example of a network node 100 which may form part of an acoustic location system according to one embodiment. In one embodiment, the network node 100 includes two acoustic sensors 102a-102b and a processing module 106 located on a vehicle 104. The vehicle may form part of a convoy or other cooperating collection of vehicles, and is therefore referred to herein as a convoy vehicle 104. The sensors 102a-102b on the convoy vehicle 104 detect acoustic events 108a-108d, and the information from the sensors may be processed by the processing module 106. As discussed further below, the vehicles in the convoy communicate over a network to share sensor data to identify the locations of the acoustic events 108a-108d.

As illustrated in FIG. 1, in one embodiment, the convoy vehicle 104, includes two sensors 102a-102b mounted on opposite sides of the vehicle 104; however, the sensors may be mounted at other locations on the vehicle. In one example, the sensors 102a and 102b are each a single sensor. In another example, the either or both sensors 102a, 102b are sensors arrays. The sensors may be positioned to maximize sound isolation between the sensors, or they may be positioned to maximize the distance between the sensors, for example.

The acoustic sensors 102a-102b receive acoustic input 110a-110d generated by the acoustic events 108a-108d. Because the sensors 102a-102b are placed at different locations on the convoy vehicle 104, the sensors 102a-102b receive the various acoustic inputs 110a-110d at different times. This time of arrival difference may be used to determine the location of the corresponding acoustic event, as discussed further below. The acoustic events 108a-108d may represent numerous different events that generate sound waves (acoustic input 110a-110d) that can be detected by the acoustic sensor 102a. In one embodiment, the acoustic sensor 102b is acoustically isolated from the acoustic sensor 102a, and does not detect the acoustic events 108a-108c since they occur on the far side of the vehicle 104. In another embodiment, the acoustic sensor 102b detects the sound waves generated by the acoustic events 108a-108d. In one example, the first acoustic source 108a is an explosion, the second acoustic source 108b is a large arms discharge, the third acoustic source 108c is mortar discharge, and the fourth acoustic source 108d is sniper rifle discharge. The acoustic inputs 110a-110d each include different frequencies. The sensors 102a-102b relay the received acoustic input 110a-110d to the processing module 106. In one example, the processing module 106 analyzes the arrival times, frequencies, and other characteristics of the acoustic input 110a-110d and thereby differentiates the various acoustic inputs 110a-110d and determines locations of the acoustic events 108a-108d, as discussed further below.

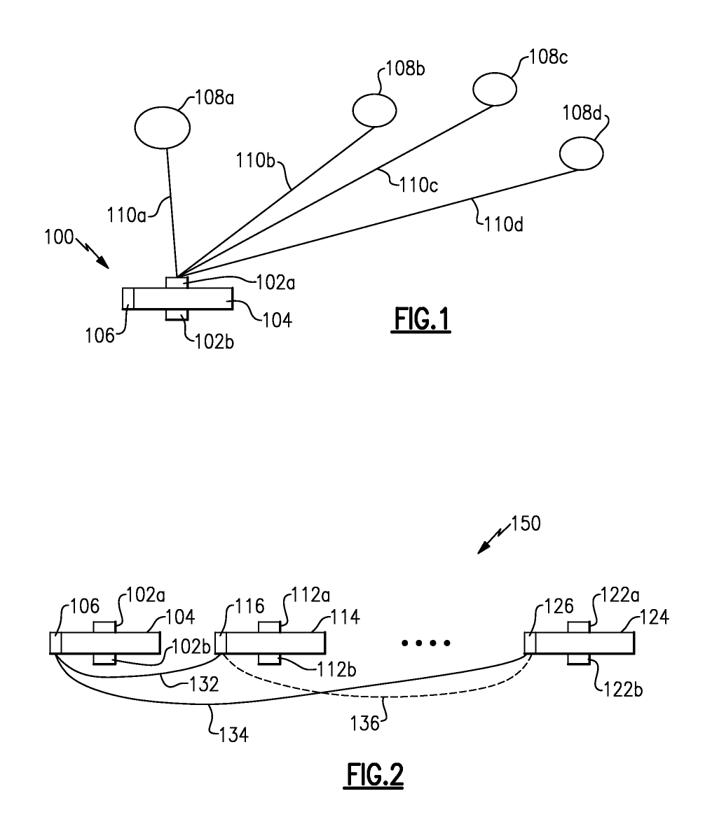

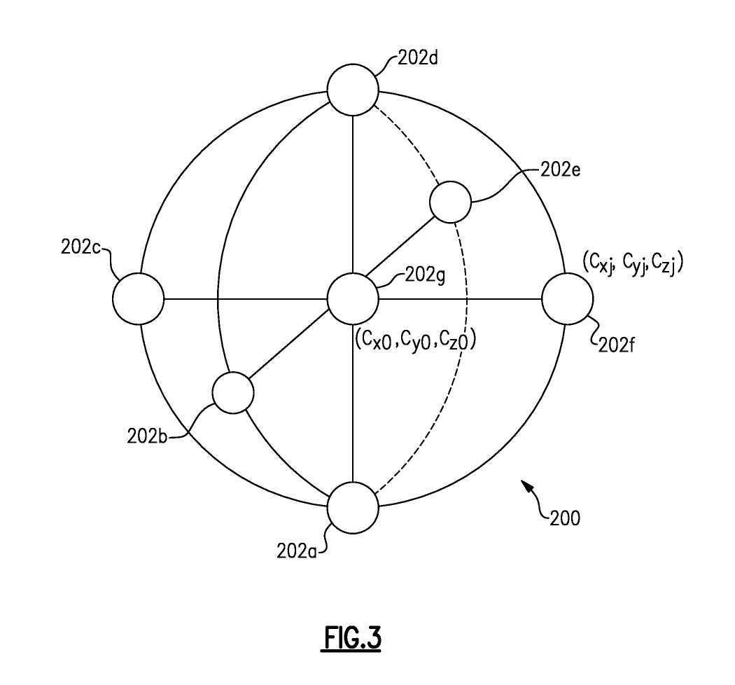

FIG. 2 is a schematic diagram of a convoy 150 of vehicles 104, 114, 124 having sensors 102a-102b, 112a-112b, and 122a-122b, and processing modules 106, 116, and 126, respectively, and configured to communicate over a network, according to one embodiment. The sensors 102a-102b, 112a-112b and 122a-122b, in conjunction with the network formed by the processing modules 106, 116 and 126, form a sensor array spanning multiple vehicles 104, 114 and 124. Although three vehicles 104, 114 and 124 are shown in FIG. 2, the convoy 150 may include any number of vehicles. In addition, although the following discussion may refer primarily to a convoy, the vehicles need not be part of a traditional “convoy,” but may be any group or collection of cooperating vehicles that are located in relatively close proximity to one another. The convoy 150 may also include one or more non-mobile platforms (not shown) equipped with acoustic sensors. As discussed further below, according to one aspect, having sensors 102a-102b, 112b-112b and 122a-122b located on separate vehicles 104, 114 and 124 connected over a network allows for more accurate location of environmental acoustic events than is achieved using multiple sensors on a single vehicle, since there can be a greater distance between the sensors in the sensor array. According to one feature, the greater distance between the sensors provides an expanded interferometer base for determination of angle of arrival of incoming acoustic data.

According to one embodiment, one or more of the processing modules on the vehicles in the convoy 150 is designated a master processing module that collects and processes information from all or at least some of the vehicles in the convoy. For example, the processing module 106 in the first vehicle 104 may be designated the master processing module, and the second 116 and third 126 processing modules may wirelessly transmit data 132 and data 134 to the first processing module 106, as illustrated in FIG. 2. In one embodiment, the processing module on each vehicle performs calculations on the acoustic signal data before transmitting the data to the master processing unit. For example, the processing module 116 on vehicle 114 may incorporate data from the sensors 112a-112b on the vehicle 114 to determine an approximate location of the acoustic event. The processing module 116 may transmit the incorporated data to the master processing unit 106.

In one embodiment, the master processing module 106 may require location information about the other vehicles in the convoy 150 in order to process the data it receives from each vehicle and accurately determine the location(s) of the acoustic event(s). Accordingly, each vehicle 104, 114 and 124 may include a navigation unit, such as a GPS (global positioning system) module and/or an IMU (inertial motion unit), that provides location data about the vehicle. The processing module in each vehicle may incorporate location data from its navigation unit with the acoustic signal data from sensors before providing the combined data to the master processing module 106. For example, the location coordinates of each acoustic sensor (or sets of sensors on each vehicle) may be approximated using data from the vehicle's navigation unit, and the processing module on each vehicle correlates incoming signals with the location coordinates of the sensor at the time the sensor received the signals. The processing module then transmits the combined data to the master processing module. Thus, the system may establish the relative location of each of the sensors positioned on vehicles in the convoy 150 and use this information to process the acoustic signal data and determine the location(s) of the acoustic event(s).

In another embodiment, the processing modules 116, 126 may be configured to transmit acoustic signal data to the master processing unit only for specific acoustic events, since processing all sounds received by the acoustic sensors on the vehicles may be processor-intensive and unnecessary. For example, the processing module may transmit signal data to the master processing unit only for low frequency acoustic events. In another example, data related to specific acoustic events is transmitted to the master processing module. The bandwidth used to correlate the data transmitted from the other processing modules may be significantly smaller than the bandwidth used in a single vehicle for continuous coordination of acoustic event data.

According to another feature, the processing modules on each vehicle 104, 114 and 124 establish an ad hoc self-healing network, such that any of the processing modules may take over as the master processing module if the current master processing module stops functioning. The network of processing modules may make a real time determination regarding whether the current master processing module is functional and, if the master processing module is not functional, the network makes a real time selection of a new master processing module. Thus, if the vehicle in a convoy with the master processing module is damaged and the master processing module is no longer functional, the processing modules on the other vehicles in the convoy reconfigure the network such that a different processing module becomes the master processing module. According to one feature, the processing modules and sensors continue to form a network as long as there are two functional processing modules. According to another feature, the processing module on any vehicle 104, 114, 124 may be the master processing module and that vehicle may become the primary coordination vehicle. The other vehicles provide system redundancy and enhance system survivability. For example, if the first processing module 106 is not functional, the second 116 or third 126 processing module will become the master processing module. In one example the second processing module 116 becomes the master processing module, and the third processing module 126 transmits data 136 to the second processing module 116.

According to one embodiment, the processing modules 106, 116 and 126 on each vehicle 104, 114 and 124 establish an adhoc wireless ad hoc network. The ad hoc network does not rely on any wired infrastructure between processing modules. Each processing module in the vehicle convoy acts as a node in the ad hoc network. Each processing module transmits data to the master processing module, and each processing module may also forward data from other processing modules to the master processing module. Thus, the network is redundant in that one processing module may send data to multiple other processing modules. Furthermore, the wireless ad hoc network is dynamic, such that a selected processing module may dynamically determine which other processing module to transmit data to. According to one feature, the network may be self-organizing, and a processing module may determine which other processing module to transmit data to based on network connectivity.

As discussed above with reference to FIG. 1, each convoy vehicle 104 may include two sensors 102a-102b which can be located on opposite sides of the vehicle. Some advantages may be obtained from this sensor configuration, including the spatial diversity obtained from having the sensors 102a-102b on either side of the vehicle, sound isolation achieved by using the vehicle superstructure to block sound from the opposite side of the vehicle, and optionally the ability to provide individual noise cancelling for each sensor. However, the vehicle 104 may include only a single sensor 102a, or may include more than two sensors. In one example, the convoy vehicle 104 includes multiple sensors arranged to maximize the distance between each sensor on the vehicle. According to one embodiment, a dedicated noise cancelling node is provided for each sensor 102a-102b. As a result, the limitations of applying an estimated transfer function to the sensors may be avoided, and the noise cancellation processing may be more accurate.

In addition, beam forming software algorithms may be applied to enhance wideband noise cancelling of the noise originating at the vehicle 104 (“self-noise”), thereby enhancing the detection range of the acoustic sensors 102a-102b. In one example, with multiple sensors, beam forming software algorithms form a receive beam by combining the time gates of the signals from each sensor. To receive sounds only from a selected direction, beam forming software algorithms process the amplitude and phase of each sound to steer the receive beam in the selected direction. In one example, beam forming software algorithms may be used to steer away from a particular noise source. In another example, beam forming software algorithms may be used to steer towards selected areas of interest. According to one feature, beam forming software algorithms can more accurately select sounds only from a selected direction when the sounds are at frequencies greater than about 1 kHz. Beam forming software algorithms are less accurate at selecting sounds only from a selected direction frequencies less than 1 kHz, since the wavelengths of low frequency sounds are large. According to one feature, including data from sensors located on different vehicles allows for greater spacing between sensors and increases the accuracy of location for low frequency sound sources.

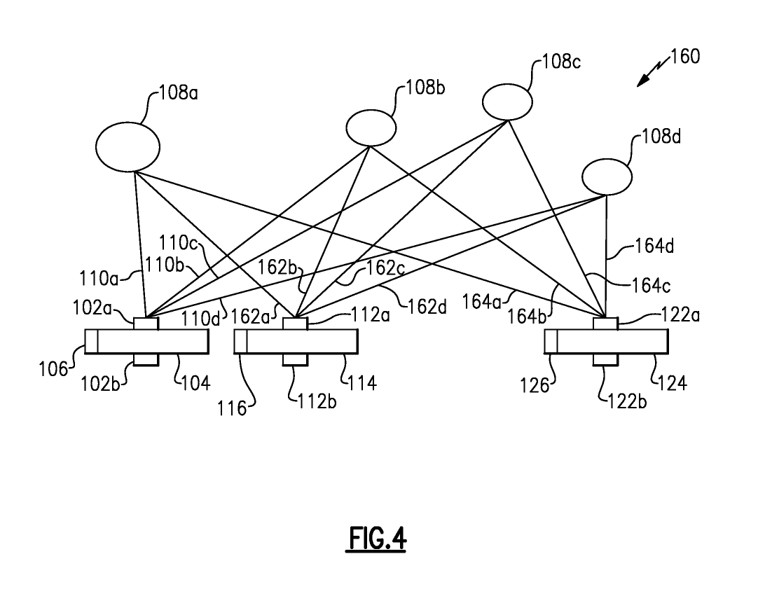

According to one example, the location of an acoustic event may be calculated using a shockwave time of arrival model based on measurements at various sensor elements in a small sensor element array located at a single position on a vehicle as described in greater detail with respect to FIG. 3. In this example the shockwave corresponds the acoustic input 110a-110d. An exemplary shockwave time of arrival model is described in U.S. Pat. No. 7,359,285, the entirety of which is hereby incorporated by reference herein. According to one embodiment, the methods discussed in U.S. Pat. No. 7,359,285 may be modified to make calculations based on sensors (or sensor arrays) positioned at disperse locations. For example, the time of arrival model using sensors mounted at a single location, as discussed in U.S. Pat. No. 7,359,285, may be modified to accept data from sensors mounted at other locations on the vehicle, as well as from sensors located on other vehicles, and to account for the larger distances between sensors or sensor arrays positioned at greater distances from one another and on different vehicles. Such modifications may be in several dimensions, based on the manner in which the results from the multiple sensors are combined. In one example, the measurements from all sensors may be adjusted to a single reference system using the accompanying location information (e.g., from each vehicle's GPS unit or other navigation unit) and making adjustments based on the relative location of each sensor during each acoustic event. This reference system may correspond to a designated location on the vehicle having the master processing module, for example. The directionality of the dispersed sensors may also be used to determine the direction of the detected shockwave. In another example, the correlation matrix of the sensor measurements used in the methods discussed in U.S. Pat. No. 7,359,285 may be adjusted to account for the diverse locations on the sensors.

In another example, the location of an acoustic event may be estimated using an interferometer calculation from measurements taken at two disperse locations. A minimum least squares estimate may be used to identify the location of an acoustic event when sensors are positioned at more than two locations. For example, the processing module 106 may use a minimum least squares estimate in processing input from the sensors 102a and 102b on the vehicle 104 of FIG. 1. In other embodiments, other weighting techniques may be used to combine the input from sensors positioned at more than two locations and identify the location of an acoustic event.

As discussed above, in another embodiment, one or both of the sensors 102a and 102b may be sensor element arrays. One example of a sensor array is described in U.S. Pat. No. 7,126,877, which is hereby incorporated by reference herein in its entirety. FIG. 3 is a schematic diagram of an exemplary sensor array 200 including seven sensor elements 202a-202g, according to one embodiment. In one example, the sensor elements 202a-202g are distributed at locations C (Cₓⱼ, C_{yj}, C_{zj}) over a spherical surface, with one sensor element 202g at the center of the sphere at Cₓ₀, C_{y0}, C_{z0}. In other examples, the sensors 102a and 102b are single sensors distributed over the surface of a vehicle.

Referring to FIG. 3, the time instant that a first sensor element, designated as the reference sensor element, detects the advancing acoustic sound wave (or shockwave) is denoted t₀. The other sensor elements detect the advancing sound wave at subsequent times denoted as tᵢ. The sound propagation distances in the direction of the advancing sounds wave are obtained by multiplying each of the time differences by the local speed of sound c, i.e., dᵢ=c(tᵢ−t₀). If there are no measurement errors, then the sound wave passing though the reference sensor element is also determined by the other six sensor elements, with the three-dimensional coordinates of the six points ideally determining all parameters of the sound wave. However, as noted above, errors in the arrival time measurements and sensor coordinates can result in erroneous parameters for the sound wave and hence also of the projectile's trajectory. Time-difference of arrival precisions which aid in making correct decisions about two otherwise ambiguous trajectory angles are described in U.S. Pat. No. 7,126,877. Other algorithms for determining acoustic source location are described in U.S. Pat. No. 7,359,285. According to one feature, the algorithms may be applied to sensors distributed over the surface of a vehicle.

According to one embodiment, the vehicles in the convoy may include other types of sensors, such as electro-optical, infrared or radar sensors. An electro-optical sensor may detect a flash, thereby providing some location data. Infrared sensors detect thermal changes. For example, an infrared sensor may detect the heat from an explosion or gunshot, providing location information. Radar sensors, such as radiofrequency sensors, may detect large projectiles. The location data from an electro-optical sensor, a thermal sensor or a radar sensor may be incorporated with data from the acoustic sensors 102a-102b, 112a-112b and 122a-122b at the processing module. In one example, acoustic sensor information may cue a radar system to being scanning for incoming radiofrequency signals. According to one feature, combining sensor functions may provide more accurate source location information. In one example, cross-cueing is used by a processing module to combine detection, geolocation and targeting information from various types of sensors.

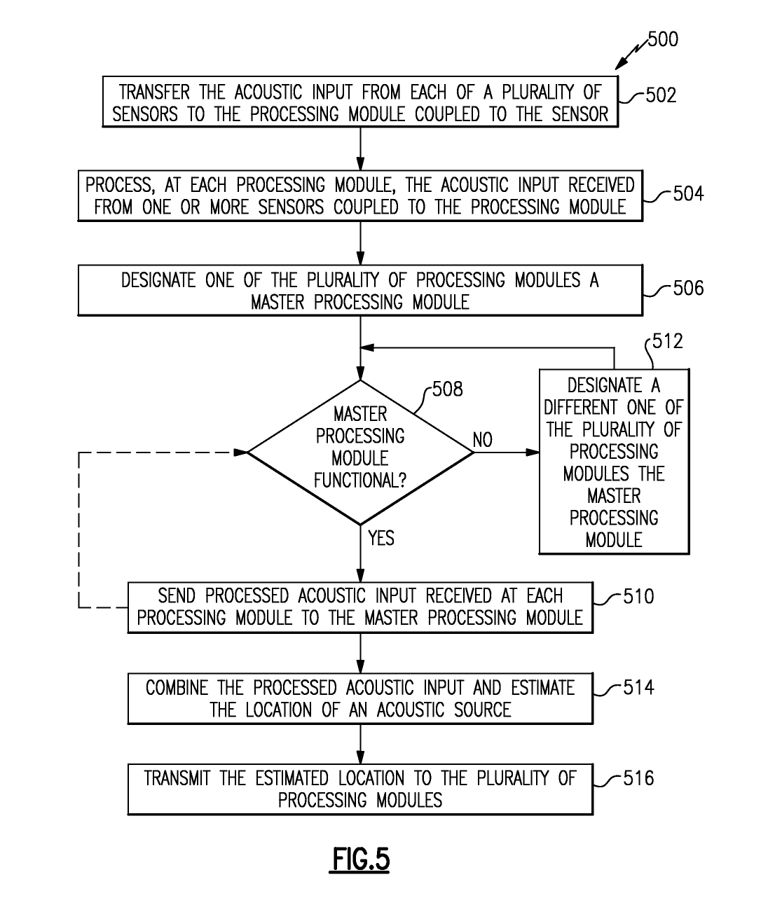

FIG. 4 is a schematic diagram 160 of a convoy of vehicles 104, 114, and 124 having sensors 102a-102b, 112b-112b, 122a-122b and detecting acoustic events 108a-108d, according to an embodiment of the invention. The convoy of vehicles 104, 114 and 124 may communicate using processing modules 106, 116 and 126 to form a network as described with respect to FIG. 2. The first sensor 102a on the first vehicle 104 detects the acoustic event 108a from the incoming acoustic input 110a, it detects the acoustic event 108b from the incoming acoustic input 110b, it detects the acoustic event 108c from the incoming acoustic input 110c, and it detects the acoustic event 108d from the incoming acoustic input 110d. The acoustic inputs 110a-110d may be a sound wave or shockwave, as discussed above. The second sensor 102b on the first vehicle 104 may also sense the acoustic events 108a-108d from the incoming acoustic input. Since the acoustic events 108a-108d are closer to the first sensor 102a, sound waves from the acoustic events 108a-108d arrive at the sensor 102b at a later time than the arrival of the sounds waves at the first sensor 102a. According to one embodiment, the time difference of arrival may used to determine the location of the acoustic event using interferometric principles in combination with the location information from each vehicle.

As shown in FIG. 4, the third sensor 112a on the second vehicle 114 detects the acoustic events 108a-108d from the incoming acoustic inputs 162a-162d. Similarly, the fifth sensor 122a on the third vehicle 124 detects the acoustic events 108a-108d from the incoming acoustic inputs 164a-164d. As described with respect to FIG. 3, the processing module 116 on the second vehicle 114 processes the input from the third sensor 112a, as well as input from the fourth sensor 112b, and transmits the processed input to the central processing module 106. Similarly, the processing module 126 on the third vehicle 124 processes the input from the fifth sensor 122a, as well as input from the sixth sensor 122b, and transmits the processed input to the central processing module 106. According to one feature, the multisensory array, including sensors 102a-102b, 112a-112b and 122a-122b, provides a highly accurate line-of-bearing due to the larger available interferometer base and information from multiple disperse sensors. According to one feature, the line-of-bearing in the multi-sensor array including sensors 102a-102b, 112a-112b and 122a-122b is more accurate than the line-of-bearing in a system that only uses sensors on a single vehicle. According to one example, location precision on individual vehicles is less accurate for low frequency sounds than for high frequency sounds, and combining the location information from multiple vehicles increases the accuracy of location information, especially for low frequency sounds

FIG. 5 is a flow chart of a convoy-based method 500 of locating an acoustic source. The method may be implemented in a convoy of vehicles, such as the vehicles 104, 114 and 124 shown in FIG. 2 and FIG. 4 and discussed above. Each vehicle includes a processing module and one or more sensors configured to receive acoustic input. At step 502, the acoustic input from each sensor is transferred to the processing module coupled to the sensor. At step 504, each processing module processes the acoustic input it receives from one or more sensors. According to one embodiment, the processing at step 504 includes processing input received from a GPS module indicating the location of the vehicle when the sensor received the acoustic input. Each processing module processes the GPS input with the input from the sensors. In another embodiment, the processing at step 504 includes processing input received from IMU module indicating the location of the vehicle when the sensor received the acoustic input. In one embodiment, each processing module processes the IMU input with the GPS input and the acoustic input.

At step 506, at least one of the processing modules is designated the master processing module. At step 508, one or more of the processing modules determines whether the master processing module is functional. If the master processing module is functioning, at step 510, the other processing modules send processed acoustic input to the master processing module. At step 514, the master processing module combines the processed acoustic input and estimates the location of the acoustic source. At step 516, the master processing module transmits the estimated location of the acoustic source to the other processing modules.

At step 508, if the master processing module is not functioning, then at step 512, a different one of the processing modules is designated the master processing module. The method 500 then returns to step 508 to determine if the new master processing module is functional. According to one feature, steps 508 and 512 repeat until a functional master processing module is found. According to one embodiment, the processing modules form an ad hoc network, in which each of the processing modules may transmit data to any of the other processing modules for transmission to the master processing module. According to one embodiment, the method returns from step 510 to step 508 at regular intervals to ensure that the master processing module is still functioning.

Accordingly, various aspects and embodiments are directed to a system and method of locating an acoustic source using sensors distributed over a convoy of vehicles, as discussed above. Processing modules on each vehicle communicate to form a self-healing network, in which the processing module designated the master processing module may change. In some embodiments, the network is an ad hoc network, in which each of the processing modules may communicate with any other one of the processing modules. These approaches allow existing convoy vehicles to be modified to enable more accurate identification of the location of an acoustic source.

Having described above several aspects of at least one embodiment, it is to be appreciated various alterations, modifications, and improvements will readily occur to those skilled in the art. Such alterations, modifications, and improvements are intended to be part of this disclosure and are intended to be within the scope of the invention. Accordingly, the foregoing description and drawings are by way of example only, and the scope of the invention should be determined from proper construction of the appended claims, and their equivalents.

What is claimed is:

1. A method of locating an acoustic source using a plurality of vehicles, comprising:
transferring acoustic input from a plurality of sensors to a plurality of processing modules, wherein each of the plurality of sensors is coupled to one of the plurality of processing modules, and wherein each of the plurality of vehicles includes at least one of the plurality of sensors and one of the plurality of processing modules;
determining a location of each of the plurality of vehicles using at least one of a global positioning system module and an inertial motion unit module located in each vehicle;
processing, at each of the plurality of processing modules, the received acoustic input;
designating one of the plurality of processing modules a master processing module;
sending processed acoustic input received at each processing module to the master processing module;
combining the processed acoustic input at the master processing module; and
estimating acoustic source location based on combined processed acoustic data.

2. The method of claim 1, further comprising:
determining if the master processing module is functional, and
responsive to determining that the master processing module is not functional, designating a different one of the plurality of processing modules as the master processing module.

3. The method of claim 1, wherein processing includes processing, at each of the plurality of processing modules, location information for the corresponding one of the plurality of vehicles on which the respective processing module is positioned.

4. The method of claim 1, wherein each of the plurality of processing modules communicates with each of the other processing modules

5. The method of claim 4, further comprising selecting, at each processing module, a subset of the plurality of processing modules with which to communicate, based on processor network connectivity.

6. The method of claim 1, wherein processing the received acoustic input includes performing noise cancelation on the received acoustic input.

7. The method of claim 1, further comprising:
sending first processed acoustic input received at a first processing module of the plurality of processing modules to a second processing module of the plurality of processing modules; and
sending the first processed acoustic input from the second processing module to the master processing module.

8. The method of claim 1, wherein transferring acoustic input from the plurality of sensors includes transferring input from a plurality of arrays of sensor elements.

9. The method of claim 1, wherein estimating the acoustic source location includes calculating a minimum least squares estimate.

10. The method of claim 1, wherein estimating the acoustic source location includes comparing times of arrival of the acoustic input at each of the plurality of sensors.

11. The method of claim 1, wherein sending the processed acoustic input received at each processing module to the master processing module includes forming, with the plurality of vehicles, an interferometer base for acoustic detection.

12. A system for locating an acoustic source, comprising:
a plurality of sensors, including a first sensor positioned on a first vehicle and a second sensor positioned on a second vehicle;
a plurality of processing modules, including a first processing module positioned on the first vehicle and coupled to the first sensor and a second processing module positioned on the second vehicle and coupled to the second sensor;
a plurality of global positioning system modules, including a first global positioning system module positioned on the first vehicle, wherein the first global positioning system transmits vehicle location information to the first processing module
wherein the plurality of processing modules are connected in an ad hoc self-healing network such that each processing module of the plurality of processing modules is configured to receive data from the plurality of processing modules and process the data to determine the location of an event.

13. The system of claim 12, further comprising a plurality of inertial motion unit modules, including a first inertial motion unit module positioned on the first vehicle, wherein the first inertial motion unit transmits vehicle movement information to the first processing module.

14. The system of claim 12, wherein each of the plurality of sensors includes an array of sensor elements.

15. The system of claim 12, wherein each of the plurality of sensors is one of an acoustic sensor, an electro-optical sensor, an infrared sensor and a radar sensor.

16. The system of claim 12, further comprising a convoy of vehicles, wherein the first vehicle and the second vehicle are part of the convoy.

17. The system of claim 12, further comprising at least one noise cancelling node positioned on one of the first vehicle and the second vehicle.

18. The system of claim 12, wherein the first sensor is positioned on a first side of the first vehicle and a third sensor is positioned on a second side of the first vehicle, and the first and third sensors are positioned to maximize sound isolation between the first and third sensors.

19. The system of claim 12, wherein the first and second vehicles form an interferometer base for acoustic detection.
